(19) United States
(12) Patent Application Publication
(10) Pub. No.: US 2025/0021615 A1
(43) Pub. Date: Jan. 16, 2025

(54) DECISION VARIABLE CALCULATION METHOD

(71) Applicant: METATECH (AP) INC., New Taipei City (TW)

(72) Inventors: YING-CHEN YANG, Taipei City (TW); TZU-LUNG SUN, New Taipei City (TW); YEONG-SUNG LIN, Taipei (TW); TSUNG-CHI CHEN, New Taipei City (TW)

(21) Appl. No.: 18/764,950

(22) Filed: Jul. 5, 2024

Related U.S. Application Data
(60) Provisional application No. 63/525,786, filed on Jul. 10, 2023.

(51) Int. Cl. G06F 17/11

(52) U.S. Cl. CPC G06F 17/11

(57) ABSTRACT

A decision variable calculation method allowing a of reverse derivation requester to calculate decision variables based on a target result by pre-trained models provided by some participants in federated learning. The method includes the steps of providing the target result to each pre-trained model participating in this method and allowing them to reversely derive the input parameters, forming a loss function based on the difference between each pre-trained model and target result, integrating all input parameters into a total input parameter, and integrating all loss functions into a total loss function. An optimization problem is then constructed by the total input parameters and the total loss function. The solution to the optimization problem is the required decision variables. By this method, reverse derivation of the decision variables can be achieved by the participants of federated learning without explicitly calculating a global model by federated learning, further avoiding cost and privacy issues arising from the exchange of data and model parameters.

### BACKGROUND OF THE INVENTION

### 1. Field of the Invention

The present invention relates to a decision variable calculation method, particularly to a calculating method for reversely deriving the decision variables corresponding to the target result by a plurality of pre-trained AI predictive models provided by the participants in federated learning.

### 2. Description of the Prior Art

With the advancement of medical engineering technology, the application of regenerative medicine in clinical disease treatments has become more diverse and increasingly attracts attention from various sectors. Regenerative medicine is primarily applied in organ repair, immune cell therapy, and stem cell therapy. Cell therapy involves using the body's cells, which are cultivated or processed ex vivo before reintroducing into the patient's body. Therefore, effectively cultivating cells is a crucial aspect of regenerative medicine. Previous studies have shown that each individual's cells possess unique characteristics, and the cells must be customized according to individual cases to increase their suitability for treatment, adding complexity and difficulty to the cell production process. With a large amount of cell and bioprocess data available, using machine learning to generate predictive models for assessing cell cultivation conditions and the effect of the process parameters is feasible, thus potentially reducing the complexity and difficulty of customizing cell processes. However, the cell and bioprocess data are often sensitive and private personal data, such as patient cell data from different hospitals or laboratories. The traditional centralized machine learning methods, which require aggregating all bioprocess data on a central server for analysis and training, might not be used or restricted by regulatory, privacy protection, and commercial considerations. Moreover, centralized machine learning methods face similar issues in medical engineering and any field where the data are sensitive and private.

Federated learning, or collaborative learning, is a machine learning technique that involves training algorithms on multiple decentralized edge devices or servers, each possessing local data samples. This method differs significantly from traditional centralized machine learning techniques, where all local data sets are uploaded to a single server for machine learning training. In federated learning, multiple members train their own datasets to produce individually trained models. The trained model parameters are then uploaded to a central server, which assigns weights and aggregates all the trained model parameters to form a federated model. The federated model can then be redistributed to all members for use. Since the central server only aggregates the trained model parameters and does not directly analyze or process the datasets of the members, the sensitive and private data samples within each member's dataset do not get exposed, thus maintaining data confidentiality.

The federated model generated by the aforementioned federated aggregation algorithm can not only be used to generate predictive results based on the input decision variables but also can reversely derive the required decision variables for a target result. However, the participants in the federated learning method can also individually develop the reverse derivation functions for their own predictive models pre-trained with the local datasets, but the effectiveness of the reverse derivation functions may be less optimal. Additionally, if an entity outside the federated participants wishes to collaborate with the participants having better predictive or reverse derivation performance, it would not reveal which federated participant's predictive model best meets the needs of the external entity by testing the federated model's effectiveness.

Moreover, even though the highly sensitive and private data within each participant's dataset would not be leaked, the federated learning still requires the exchange of the model parameters between the central server and the participants. Therefore, the process of reverse derivation for the federated model to obtain decision variables is relatively complex, and the participants need to exchange the model parameters with each other.

Therefore, it is necessary to develop a method that allows the participants of federated learning to reversely derive decision variables without using the federated learning algorithm, so as to solve the problem of complexity and privacy involved in reverse deriving the decision variables through the federated model.

### SUMMARY OF THE INVENTION

In light of this, the present invention provides a decision variable calculation method to solve the aforementioned conventional problems.

According to an embodiment of the present invention, the decision variable calculation method includes the following steps: providing a plurality of pre-trained predictive models, the pre-trained predictive models being respectively obtained by performing machine learning on a plurality of local datasets through a machine learning method; providing a target result and reversely deriving a plurality of input parameters for the target result by the pre-trained predictive models respectively; respectively setting a plurality of loss functions corresponding to the pre-trained predictive models, assigning a first weight value to each of the loss functions and then summing them to generate a total loss function, wherein each of the loss functions is defined as the absolute value, square, or a monotonic increasing function of the difference between the function value of each of the pre-trained predictive models and the target result; assigning a second weight value to each of the input parameters and then summing them to generate a total input parameter, and constructing the total input parameter and the total loss function as an optimization problem; and, solving the optimization problem to obtain the second weight value of each of the input parameters to calculate the total input parameter as the decision variables.

Wherein, the decision variable calculation method further includes the following steps: respectively calculating a derivative of the total loss function to each of the second weight values; combining the derivatives to form a direction; and, increasing the total input parameter by a step size along the direction and input it into the pre-trained predictive models to judge if the function value of the total loss function decreases.

Wherein, the pre-trained predictive models are provided by a plurality of participants in a federated learning system.

Wherein, the step of reversely deriving the input parameters for the target result by the pre-trained predictive models respectively further comprises the following steps: a first participant of the participants comparing all samples in a first local dataset of the local datasets to the target result; and, making the samples in the first local dataset that match the target result as reference samples for reversely deriving the input parameter.

Wherein, the step of reversely deriving the input parameters for the target result by the pre-trained predictive models respectively further comprises the following steps: a second participant of the participants comparing all samples in a second local dataset of the local datasets to the target result to obtain a plurality of anchor samples, and forming a multi-dimensional subspace from the anchor samples; determining an initial sample within the multi-dimensional subspace; obtaining a direction of the initial sample within the multi-dimensional subspace, increasing the initial sample by a step size in the direction to form an intermediate sample, and inputting the intermediate sample into a second pre-trained predictive model provided by the second participant to confirm whether a predictive result generated by the second pre-trained predictive model approaches the target result; and, continuously performing the steps of determining the direction, increasing the intermediate sample by the step size, and inputting the intermediate sample into the second pre-trained predictive model until the predictive result generated by the second pre-trained predictive model matches the target result, and making the last intermediate sample as the input parameter corresponding to the second pre-trained predictive model.

Wherein, the step of reversely deriving the input parameters for the target result by the pre-trained predictive models respectively further comprises the following steps: a third participant of the participants setting a dummy layer connected to the input end of a third pre-trained predictive model to form a parameter predictive model, wherein the dummy layer is the input end of the parameter predictive model; and, setting the target result as the output of the parameter predictive model as, inputting a training dataset comprising at least one all-one vector to the parameter predictive model for training, adjusting a plurality of arc weight values between the dummy layer and the third pre-trained predictive model by an optimizer of the machine learning method that generated the third pre-trained predictive model, and making the arc weight values as the input parameters corresponding to the third pre-trained predictive model.

Wherein, the step of reversely deriving the input parameters for the target result by the pre-trained predictive models respectively further comprises the following steps: a fourth participant of the participants comparing all samples of a fourth local dataset in the local datasets to the target result to obtain a plurality of anchor samples, and forming a multi-dimensional subspace from the anchor samples; determining an initial sample within the multi-dimensional subspace; by an optimizer employed by the fourth participant to generate a fourth pre-trained predictive model, performing a minimization calculation on an objective function of the fourth-trained predictive model to obtain a gradient, and taking the reverse of the gradient as a direction of the initial sample; increasing the initial sample by a step size in the direction to form an intermediate sample, and inputting the intermediate sample into the fourth pre-trained predictive model to confirm whether a predictive result generated by the fourth pre-trained predictive model is close to the target result; and, continuously performing the steps of determining the direction, increasing the intermediate sample by the step size, and inputting the intermediate sample into the fourth pre-trained predictive model until the predictive result generated by the fourth pre-trained predictive model matches the target result, and making the last intermediate sample as the input parameter corresponding to the fourth pre-trained predictive model.

Wherein, the step of reversely deriving the input parameters for the target result by the pre-trained predictive models respectively further comprises the following steps: providing a plurality of confirmed decision variables and calculating a first vector for the confirmed decision variables; obtaining corresponding sample parameters from the sample parameters of all samples in the fourth local dataset based on the confirmed decision variables, and calculating a second vector for the corresponding sample parameters; comparing the first vector with the second vectors while also comparing the predictive result generated by the fourth pre-trained predictive model for all samples in the fourth local dataset with the target result to obtain a reference sample, wherein the second vector of the reference sample is close to or matches the first vector, and the predictive result of the reference sample is close to or matches the target result; and, making the reference sample as the initial sample.

Wherein, the decision variable calculation method further comprises the following steps: providing a test sample, wherein the test sample comprises a plurality of confirmed test input parameters and a confirmed test target result; and, inputting the confirmed test input parameters into a plurality of candidate pre-trained predictive models, and selecting the candidate pre-trained predictive models having the output results matching the confirmed test target result as the pre-trained predictive models.

Wherein, the decision variable calculation method further includes the following steps: providing a first test sample, wherein the first test sample comprises a plurality of first confirmed test input parameters and a first confirmed test target result; inputting the first confirmed test input parameters into a plurality of candidate pre-trained predictive models, and selecting the candidate pre-trained predictive models having the output results matching the first confirmed test target result as first candidate pre-trained predictive models; providing a second test sample, wherein the second test sample comprises a plurality of second confirmed test input parameters and a second confirmed test target result; and, providing the second test target result to the first candidate-trained predictive models, the first candidate-trained predictive models reversely deriving a plurality of first candidate input parameters respectively, and selecting the first candidate-trained predictive models, having the first candidate input parameters matching or close to the second confirmed test input parameters as the pre-trained predictive models, or having the first candidate input parameters meeting a validity confirming process, as the pre-trained predictive models.

In summary, the decision variable calculation method of the present invention can reversely derive the input parameters, i.e., the decision variables, those meet specific target result through pre-trained predictive models provided by multiple participants in federated learning without performing the federated learning process. By the method of the present invention, specific participants in federated learning or an entity outside of the participants of federated learning can apply reverse derivation requests, directly seeking for and selecting collaborators without relying on the federated model generated by federated learning, thereby avoiding more complex machine learning and reverse derivation procedures. Additionally, in the decision variable calculation method of the present invention, the participants of federated learning do not need to exchange sensitive and highly private sample information within their training datasets, nor do they need to exchange model parameters of their pre-trained predictive models. As a result, procedural complexity is reduced, and data confidentiality is further improved.

The advantages and spirit of the present invention can be further understood by the following detailed description and with reference to the diagrams.

### BRIEF DESCRIPTION OF THE APPENDED DRAWINGS

FIG. 1 is a flowchart diagram illustrating method for calculating decision variables according to an embodiment of the present invention.

FIG. 2 is a flowchart diagram illustrating further steps of step S18 in FIG. 1.

FIG. 3 is a flowchart diagram illustrating method for calculating decision variables according to another embodiment of the present invention.

FIG. 4 is a flowchart diagram illustrating method for calculating decision variables according to another embodiment of the present invention.

FIG. 5 is a flowchart diagram illustrating method for calculating decision variables according to another embodiment of the present invention.

FIG. 6 is a flowchart diagram illustrating method for calculating decision variables according to another embodiment of the present invention.

FIG. 7 is a flowchart diagram illustrating method for calculating decision variables according to another embodiment of the present invention.

FIG. 8 is a flowchart diagram illustrating method for calculating decision variables according to another embodiment of the present invention.

### DETAILED DESCRIPTION OF THE INVENTION

To make this invention's advantages, spirit, and characteristics more accessible and straightforward, detailed explanations and discussions will be provided through specific embodiments, referring to the accompanying diagrams. It is important to note that these particular embodiments merely represent this invention, and the exact methods, devices, conditions, materials, etc., mentioned are not intended to limit the invention or its corresponding specific embodiments. Additionally, the components in the diagrams are used only to express their relative positions and are not drawn to scale. The step numbers used in the description of this invention are for distinguishing different steps and do not represent the order of the steps, which is clarified here for better understanding.

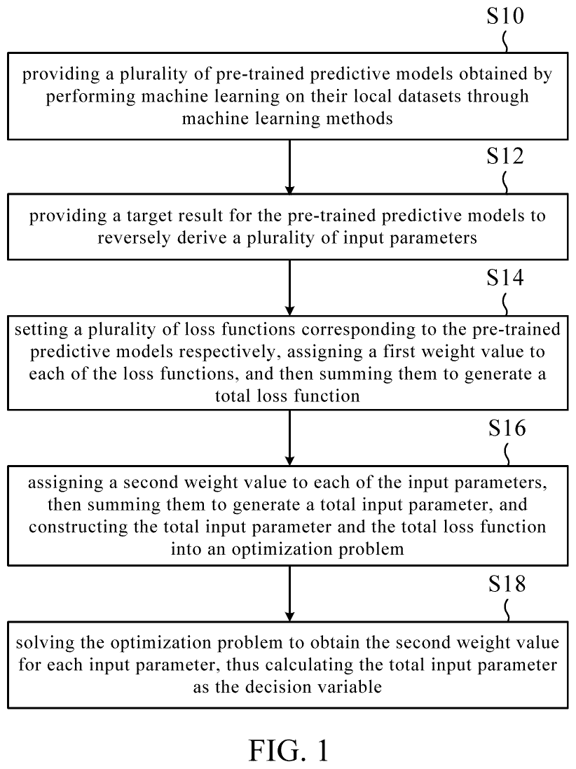

Please refer to FIG. 1. FIG. 1 is a flowchart diagram illustrating a decision variable calculation method according to an embodiment of the present invention. As shown in FIG. 1, the decision variable calculation method of the present embodiment includes the following steps: step S10: providing a plurality of pre-trained predictive models obtained by performing machine learning on their local datasets through machine learning methods; step S12: providing a target result for the pre-trained predictive models to reversely derive a plurality of input parameters; step S14: setting a plurality of loss functions corresponding to the pre-trained predictive models respectively, assigning a first weight value to each of the loss functions, and then summing them to generate a total loss function; step S16: assigning a second weight value to each of the input parameters, then summing them to generate a total input parameter, and constructing the total input parameter and the total loss function into an optimization problem; and, step S18: solving the optimization problem to obtain the second weight value for each input parameter, thus calculating the total input parameter as the decision variable.

In the present embodiment, the pre-trained predictive models in step S10 are provided by the participants of federated learning. Specifically, each participant of federated learning can have its own AI model training device and local dataset, enabling each participant to train its own AI predictive model independently. For example, in the field of regenerative medicine, the AI model training device of each participant can be computer equipment in hospitals or laboratories capable of executing machine learning algorithms, and the local datasets can be sample datasets, owned by the hospitals or laboratories, for the training, validation, and test. In practice, the participants of federated learning can respectively use Artificial Neural Networks (ANNs), Convolutional Neural Networks (CNNs), Recurrent Neural Networks (RNNs), or any other machine learning algorithms or neural network algorithms to perform machine learning on their local datasets to obtain their pre-trained predictive models. The choice of machine learning algorithm depends on the needs of each participant. Furthermore, in step S10, the pre-trained predictive models are some selected from all pre-trained predictive models of federated learning. In practice, different participants of federated learning have different local datasets, machine learning algorithms, capabilities in tuning model parameters, and abilities to reversely derive decision variables through the pre-trained predictive models, so not all the pre-trained predictive models meet the requirements. The selection of the pre-trained predictive models will be explained in the later embodiments.

In step S12, the participants of federated learning providing the pre-trained predictive models can reversely derive the input parameters based on the target result. Specifically, each participant can use the same or different reverse derivation algorithms to map the target result to the output result of their pre-trained predictive models, thereby reversely deriving the input parameters that make the output result of the pre-trained predictive models to match the target result. The reverse derivation algorithm of each participant will be explained in the later embodiments.

In step S14, each pre-trained predictive model can set a loss function, defined as the absolute value, square or a monotonic increasing function of the difference (such as the fourth power or the sixth power of the difference) between the function value of the objective function representing each of the pre-trained predictive models and the target result. In other words, the loss function represents the degree of proximity between the output result of each pre-trained predictive model and the target result. The total loss function is formed by weighting and then summing the loss functions corresponding to the pre-trained predictive models. The weighting of each loss function, i.e., the first weight value, is determined in practice based on the reliability or performance of each pre-trained predictive model. For example, if the entity requesting the reverse derivation determines that a particular pre-trained predictive model has a higher influence on the target result or that the particular pre-trained predictive model has higher predictive accuracy and higher reverse derivation capability. In that case, the first weight value corresponding to the loss function of the particular pre-trained predictive model can be set higher than those corresponding to other pre-trained predictive models.

In step S16, the input parameters reversely derived by each pre-trained predictive model for the same target result can also be assigned second-weight values respectively. Unlike the first weight values in step S14, the second weight values are not predetermined but will be calculated and determined in subsequent steps. Steps S14 and S16 generate the total loss function and the total input parameter corresponding to all pre-trained predictive models, and they can be constructed into an optimization problem for calculating the most appropriate input parameters.

In step S18, solving the optimization problem involves finding the total input parameter corresponding to the minimum total loss function. Since the input parameters of the pre-trained predictive models within the total input parameter are known, the solution to the optimization problem is the second weight values. Once all the second weight values are obtained, the total input parameter can be calculated as the required decision variable.

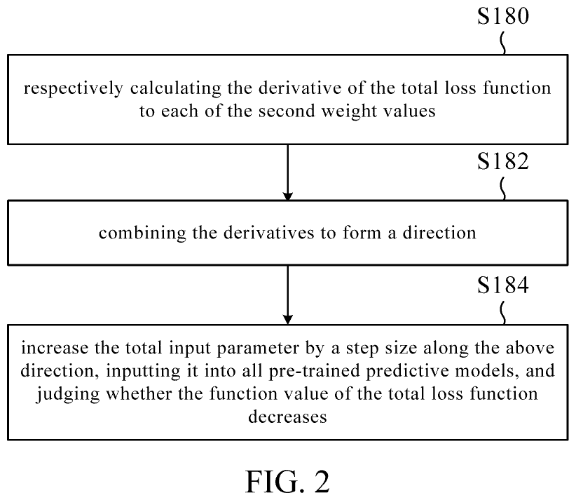

The method for solving the above optimization problem can be numerical analysis methods. Please refer to FIG. 2. FIG. 2 is a flowchart diagram illustrating Step S18 in the decision variable calculation method shown in FIG. 1. As shown in FIG. 2, step S18 can further include the following steps: step S180: respectively calculating the derivative of the total loss function to each of the second weight values; step S182: combining the derivatives to form a direction; and, step S184: increase the total input parameter by a step size along the above direction, inputting it into all pre-trained predictive models, and judging whether the function value of the total loss function decreases.

As aforementioned, the total input parameter is the sum of multiple input parameters derived in step S12 multiplied by the second weight values respectively. In other words, each of the second weight values has a different influence on the function value of the total loss function. Therefore, in step S180 of the decision variable calculation method of the present embodiment, calculating the derivative of the total loss function to each second each of the weight values means that calculating the change of the function value of the total loss function corresponding to the slight change in each second weight value. Each derivative represents the rate of change of the total loss function to the corresponding second weight value. Therefore, the direction can be obtained by multiplying each derivative by the unit vector formed from the corresponding second weight value and then summing them, as shown in step S182. After determining the direction in step S182, step S184 sets an appropriate step size along this direction to allow an appropriate decrease in the function value after substituting the increased total input parameter (after advancing one step) into the total loss function. Thus, the new total input parameter (advancing one step) leads to a smaller function value of the total loss function than the previous total input parameter does, which means it is closer to the solution of the optimization problem. Steps S180 to S182 can be repeated until the minimum function value of the total loss function is found, and at this point, the total input parameter is the solution to the optimization problem and can be the decision variable.

For example, if the decision variable calculation method selects the pre-trained predictive models provided by two participants of federated learning, the target result T can be provided to these two participants. The participants reversely derive the input parameters I₁ and I₂ through their pre-trained predictive models respectively for the target result T. Two loss functions L₁ and L₂ can be set correspondingly to these two pre-trained predictive models, wherein the loss functions L₁ and L₂ are defined as the absolute values of the differences, between the functions f₁ and f₂ representing the pre-trained predictive models and the target result, |f₁−T| and |f₂−T|, respectively. Next, the first weight values α and 1−α are assigned to the two loss functions, respectively, and then the loss functions are summed to generate the total loss function L=α×|f₁−T|+(1−α)×|f₂−T|. The second weight values β and γ are assigned to the two input parameters I₁ and I₂, respectively, and then the two input parameters are summed to generate the total input parameter S¹=β×I₁+γ×I₂. The optimization problem constructed by the total input parameter and the total loss function is to find the most appropriate β and γ that minimize the total loss function L under the condition that α, T, I₁ and I₂ are fixed.

The method for solving the aforementioned optimization problem firstly involves calculating the derivatives d₁ and d₂ of the total loss function L to the second weight values β and γ, respectively. Next, the method set the direction g=(d₁×(1,0)+d₂×(0, 1)), where (1, 0) and (0, 1) are the unit vectors for β and γ, respectively. Once the direction is determined, a step size t can be set along this direction to advance the total input parameter by the step size t, producing a new total input parameter, i.e., S²=S¹−t×g. It should be noted that the derivatives d₁ and d₂ represent the gradients of the total loss function to β and γ, and the advancement direction of the step size is the opposite direction of the gradient. By adjusting the appropriate step size t, a new total input parameter S² substituted into the total loss function L will generate a lower function value compared to the previous total input parameter S¹. Therefore, the predicted result obtained using the new total input parameter S² will be closer to the target result. Repeating the steps of calculating the direction and adjusting the step size can obtain a total input parameter that yield the minimum function value when substituted into the total loss function L, and this total input parameters can then be the decision variable calculated by the decision variable calculation method.

In the embodiments described above, the decision variable calculation method allows the participants of federated learning or the entity outside of federated learning apply reverse derivation requests and seeking for collaborators in all participants of federated learning. However, in practice, not only the participants of federated learning can provide the pre-trained predictive models, and the collaborators can also be non-participants of federated learning as long as they can independently train predictive models and use the pre-trained predictive models to reversely derive the input parameters.

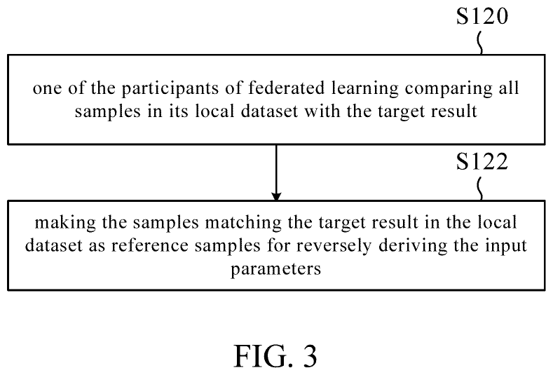

As previously mentioned, in step S12, the participants of federated learning can reversely derive the input parameters using their pre-trained predictive models based on the target result provided by the reverse derivation requester. The methods for reverse derivation can include, but not limited to, the following aspects. Please refer to FIG. 3. FIG. 3 is a flowchart diagram illustrating a decision variable calculation method according to another embodiment of the present invention. As shown in FIG. 3, the decision variable calculation method of the present embodiment further includes the following steps: step S120: one of the participants of federated learning comparing all samples in its local dataset with the target result; and, step S122: making the samples matching the target result in the local dataset as reference samples for reversely deriving the input parameters. It should be noted that in addition to steps S120 to S122, the method of the present embodiment further includes the steps S10 and S14 to S18 as shown in the previous embodiments, so that they would not be described again here.

In this embodiment, a first participant of the participants of federated learning can use the samples from its first local dataset, which was used to generate the pre-trained predictive model, as the references to derive the input parameters reversely. Specifically, if there are already confirmed decision variables (such as parameters already executed in a process) among the decision variables to be reversely derived, the confirmed decision variables can be formed into a vector. Similarly, the sample parameters corresponding to the confirmed decision variables from each of all samples in the first local dataset can be formed into another vector. By comparing these two vectors, samples with the corresponding sample parameters close to or matching the confirmed decision variables can be identified. These samples have the parameters similar to those of the confirmed decision variables, and it means that these samples have high reference values. Therefore, the other sample parameters in these samples, which do not correspond to the confirmed decision variables, along with the confirmed decision variables, can be input into the pre-trained predictive model. If the output of the pre-trained predictive model matches the target result, then the other sample parameters in these samples, along with the confirmed decision variables, can be used as the input parameters (e.g., the input above parameter I₁).

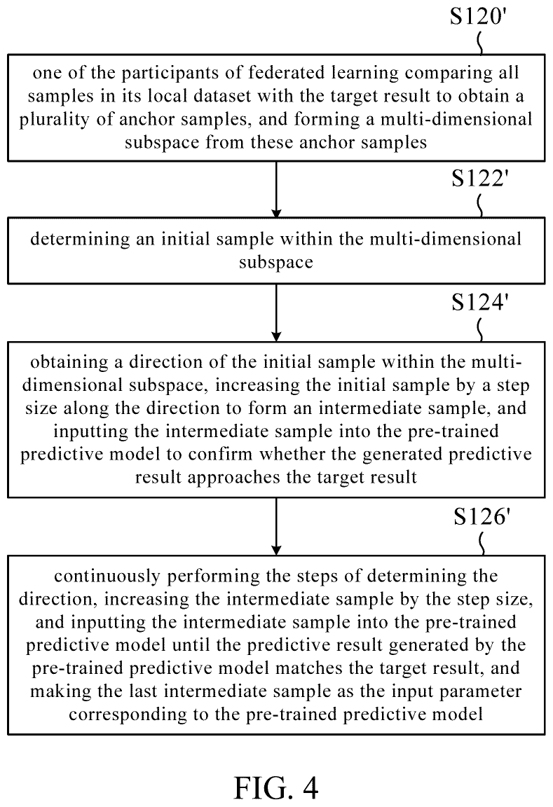

Please refer to FIG. 4. FIG. 4 is a flowchart diagram illustrating a decision variable calculation method according to another embodiment of the present invention. As shown in FIG. 4, the decision variable calculation method of the present embodiment further includes the following steps: step S120′: one of the participants of federated learning comparing all samples in its local dataset with the target result to obtain a plurality of anchor samples, and forming a multi-dimensional subspace from these anchor samples; step S122′: determining an initial sample within the multi-dimensional subspace; step S124′: obtaining a direction of the initial sample within the multi-dimensional subspace, increasing the initial sample by a step size along the direction to form an intermediate sample, and inputting the intermediate sample into the pre-trained predictive model to confirm whether the generated predictive result approaches the target result; and, step S126′: continuously performing the steps of determining the direction, increasing the intermediate sample by the step size, and inputting the intermediate sample into the pre-trained predictive model until the predictive result generated by the pre-trained predictive model matches the target result, and making the last intermediate sample as the input parameter corresponding to the pre-trained predictive model. It should be noted that in addition to steps S120′ to S126′, the method of the present embodiment further includes the steps S10 and S14 to S18 as shown in the previous embodiments, so that they would not be described again here.

In step S120′, the local dataset is composed of samples for training the pre-trained predictive model, so both the input and output of the samples to the pre-trained predictive model are known. Additionally, the samples with output results close to or matching the target result have higher reference value, and then these samples can be selected as reference samples. In the present embodiment, these samples are used as anchor samples to form a multi-dimensional subspace, which represents the feasible solution space for the optimization problem. Steps S122′, S124, and S126 describe finding the optimal feasible solution within this feasible solution space. In short, the process involves firstly determining an initial point (initial sample) within the feasible solution space, using numerical analysis methods to find the direction from the initial point, and adjusting the step size to advance to the next point (intermediate sample) that makes the predictive result of the pre-trained predictive model closer to the target result. The process of finding the direction, adjusting the step size, and moving forward is repeated until the predictive result of the pre-trained predictive model is closest to or matches the target result, and the last point is used as the input parameters. It should be noted that the method for determining the initial point or initial sample within the multi-dimensional subspace can be specified by the participant of federated learning or found through the similar steps as shown in the embodiment of FIG. 3, where a sample close to or matching the confirmed decision variables is identified and selected as the initial sample.

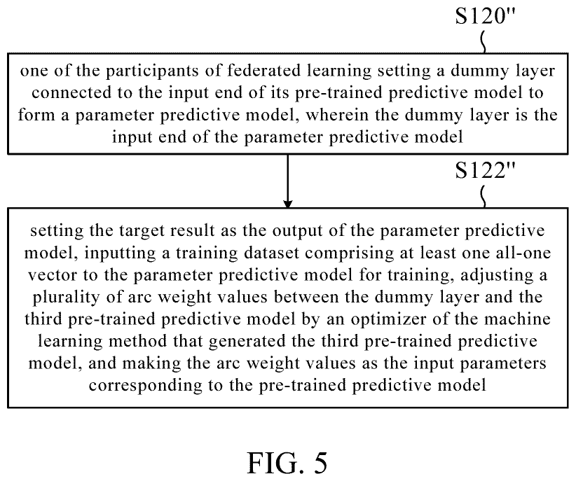

Please refer to FIG. 5. FIG. 5 is a flowchart diagram illustrates a decision variable calculation method according to another embodiment of the present invention. As shown in FIG. 5, the decision variable calculation method of the present embodiment further includes the following steps: step S120″: one of the participants of federated learning setting a dummy layer connected to the input end of its pre-trained predictive model to form a parameter predictive model, wherein the dummy layer is the input end of the parameter predictive model; step S122″: setting the target result as the output of the parameter predictive model, inputting a training dataset comprising at least one all-one vector to the parameter predictive model for training, adjusting a plurality of arc weight values between the dummy layer and the third pre-trained predictive model by an optimizer of the machine learning method that generated the third pre-trained predictive model, and making the arc weight values as the input parameters corresponding to the pre-trained predictive model. It should be noted that in addition to steps S120″ to S122″, the method of the present embodiment further includes the steps S10 and S14 to S18 as shown in the previous embodiments, so that they would not be described again here.

The dummy layer in step S120″ and the original the original pre-trained predictive model together form an extended model, i.e., the parameter predictive model. In practice, the dummy layer contains artificial neurons in the same number as the input points of the input layer of the pre-trained predictive model, and these artificial neurons can be connected to these input points respectively. Additionally, the bias value of the activation function for each artificial neuron is set to 0, so when the input value of the activation function is 1, its output would also be 1. It should be noted that although the pre-trained predictive model forms the parameter predictive model together with the dummy layer, the model parameters within the pre-trained predictive model is fixed during subsequent training. Because the inputs of the artificial neurons are 1 and their outputs is also 1, when the output of the parameter predictive model is set to a fixed result (e.g., the target result mentioned above), the optimizer will adjust the arc weight values between each artificial neuron and each input point of the pre-trained predictive model, thereby adjusting the input of the pre-trained predictive model. Thus, in step S122″, the arc weight values, obtained by setting the target result as the output of the parameter predictive model and training it with a dataset comprising at least one all-one vector, can be used as the input parameters for the pre-trained predictive model. Similarly, in practice, a sample close to or matching the confirmed decision variables can firstly be identified and selected as the initial point for the optimizer to adjust the arc weights by similar steps in the embodiment of FIG. 3.

In practice, the types of optimizers can be Adaptive Moment Estimation (Adam), Stochastic Gradient Descent (SGD), Momentum, Nesterov Accelerated Gradient (NAG), Adaptive Gradient Algorithm (AdaGrad), Nesterov-accelerated Adaptive Moment Estimation (Nadam), Root Mean Square Propagation (RMSprop), Adaptive Delta (Adadelta), Adam with Weight Decay (AdamW), Adaptive Moment Estimation with Long-term Memory (AMSGrad), Adaptive Belief (AdaBelief), Layer-wise Adaptive Rate Scaling (LARS), AdaHessian, Rectified Adam (RAdam), Lookahead, Momentumized, Adaptive, and Decentralized Gradient Descent (MadGrad), Yogi optimizer (Yogi), or Adaptive Moment Estimation with Maximum (AdamMax).

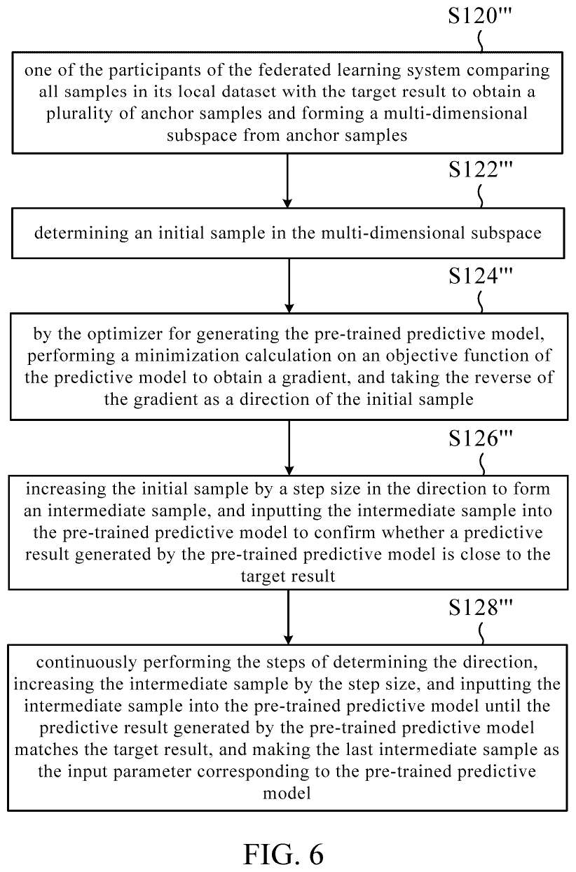

Please refer to FIG. 6. FIG. 6 is a flowchart diagram illustrating a decision variable calculation method according to another embodiment of the present invention. As shown in FIG. 6, the decision variable calculation method of the present embodiment further includes the following steps: step S120′″: one of the participants of the federated learning system comparing all samples in its local dataset with the target result to obtain a plurality of anchor samples and forming a multi-dimensional subspace from anchor samples; step S122′″: determining an initial sample in the multi-dimensional subspace; step S124′″: by the optimizer for generating the pre-trained predictive model, performing a minimization calculation on an objective function of the predictive model to obtain a gradient, and taking the reverse of the gradient as a direction of the initial sample; step S126′″: increasing the initial sample by a step size in the direction to form an intermediate sample, and inputting the intermediate sample into the pre-trained predictive model to confirm whether a predictive result generated by the pre-trained predictive model is close to the target result; and, step S128′″: continuously performing the steps of determining the direction, increasing the intermediate sample by the step size, and inputting the intermediate sample into the pre-trained predictive model until the predictive result generated by the pre-trained predictive model matches the target result, and making the last intermediate sample as the input parameter corresponding to the pre-trained predictive model. It should be note that in addition to the steps S120″ to S128′″, the method of the present embodiment further includes the steps S10 and S14 to S18 as shown in the previous embodiments, so that they would not be described again here.

In the present embodiment, the decision variable calculation method firstly finds the anchor samples to form a feasible solution space (multi-dimensional subspace) and determines the initial sample within this feasible solution space, as shown in the corresponding steps in the previous embodiments. However, the difference between this embodiment and the previous embodiments is that determination of the direction for the initial sample or intermediate samples in the present embodiment is calculated by the optimizer for generating the pre-trained predictive model. Specifically, by minimizing the objective function representing the pre-trained predictive model with the optimizer, the gradient can be obtained and the opposite direction of the gradient is the direction for the initial sample or intermediate samples. Then, the initial sample or the intermediate samples can advance for an appropriate step size along the direction obtained by the optimizer to approach the target result. When the output of the pre-trained predictive model matches the target result, this intermediate sample can be the input parameters of the pre-trained predictive model. Similar to the aforementioned embodiments, the step of determining the initial point or initial sample in the multi-dimensional subspace of the method in the present embodiment can also follow similar steps to those in the embodiment of FIG. 3, where a sample close to or matching the confirmed decision variables is identified and selected as the initial sample.

Through the aforementioned embodiments, the participants of federated learning can adopt various reverse derivation methods to calculate the corresponding input parameters (such as the input above parameters I₁ and I₂) based on the target result provided by the reverse derivation requester. However, as aforementioned, the participants of federated learning are different from each other for their local datasets, machine learning algorithms, capabilities to adjust model parameters, and the methods and capabilities of reverse derivation employed. Therefore, the reverse derivation requester must first select the pre-trained predictive models that meet the requirements to achieve efficient and accurate decision variable calculations.

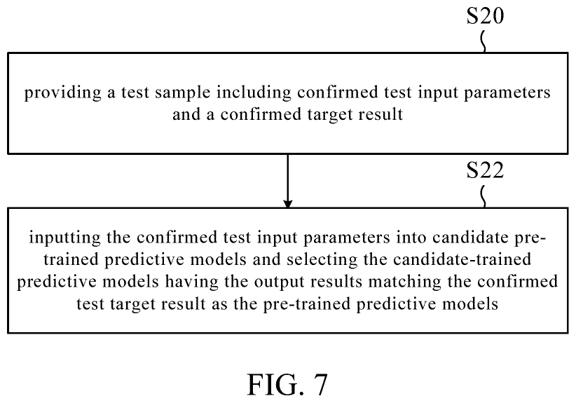

Please refer to FIG. 7. FIG. 7 is a flowchart diagram illustrating a decision variable calculation method according to another embodiment of the present invention. As shown in FIG. 7, the decision variable calculation method of this particular embodiment further includes the following steps: step S20: providing a test sample including confirmed test input parameters and a confirmed target result; step S22: inputting the confirmed test input parameters into candidate pre-trained predictive models and selecting the candidate-trained predictive models having the output results matching the confirmed test target result as the pre-trained predictive models. It should be noted that after the above steps, the decision variable calculation method of the present embodiment continues to perform other steps as shown in the previous embodiments, such as steps S10 to S18, so as to calculate the decision variables required by the reverse derivation requester. Since these steps have been described in the aforementioned embodiments, they would not be described again here.

In step S20, the reverse derivation requester can provide the existing samples with fully confirmed decision variables and results as the test samples for verifying the pre-trained predictive models of all participants in the federated learning system to select the needed pre-trained predictive models (defined as the candidate-trained predictive models in the present embodiment). Since the test input parameters and test target result in the test samples are confirmed, in step S22, the candidate-trained predictive models that receive the test input parameters and output results matching the test target result will have a prediction accuracy that meets the requester's requirements. These models can then be used as the pre-trained predictive models for the subsequent inverse derivation of decision variables.

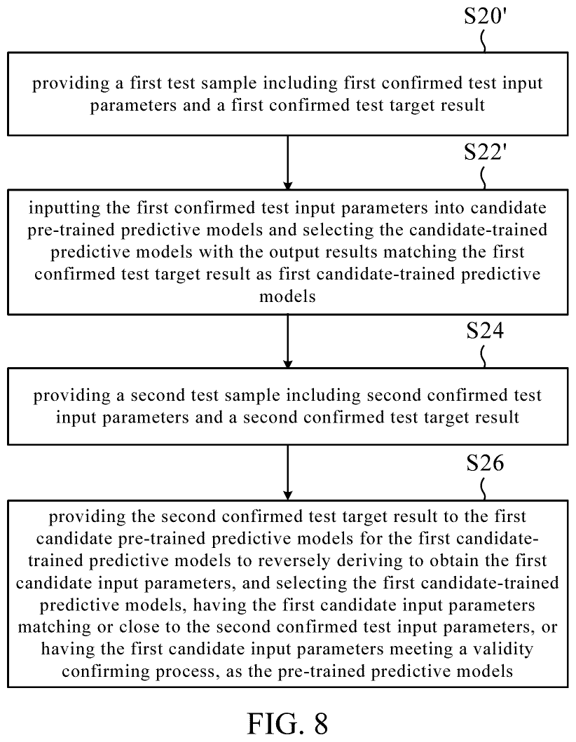

Additionally, since the decision variable calculation method of the present invention requires the participants of federated learning involved in the calculation to perform reverse derivation, as described in step S12 and its sub-steps of the aforementioned embodiments, the capabilities of the participants of federated learning to perform reverse derivation are also a requirement of the reverse derivation requester. Please refer to FIG. 8. FIG. 8 is a flowchart diagram illustrating a decision variable calculation method according to another embodiment of the present invention. As shown in FIG. 8, the decision variable calculation method of the present embodiment further includes the following steps: step S20′: providing a first test sample including first confirmed test input parameters and a first confirmed test target result; step S22′: inputting the first confirmed test input parameters into candidate pre-trained predictive models and selecting the candidate-trained predictive models with the output results matching the first confirmed test target result as first candidate-trained predictive models; step S24: providing a second test sample including second confirmed test input parameters and a second confirmed test target result; step S26: providing the second confirmed test target result to the first candidate pre-trained predictive models for the first candidate-trained predictive models to reversely deriving to obtain the first candidate input parameters, and selecting the first candidate-trained predictive models, having the first candidate input parameters matching or close to the second confirmed test input parameters, or having the first candidate input parameters meeting a validity confirming process, as the pre-trained predictive models. It should be noted that after the above steps, the decision variable calculation method of the present embodiment continues to perform other steps as shown in the previous embodiments, such as steps S10 to S18, so as to calculate the decision variables required by the reverse derivation requester. Since these steps have been described in the aforementioned embodiments, they would not be described again here.

The difference between the present embodiment and the previous embodiments is that test input parameters of the first test sample are provided to all participants in the federated learning system in the present embodiment to be inputted into their pre-trained predictive models (the pre-trained predictive models of all participants are defined as the candidate pre-trained predictive models in this specific embodiment), and all pre-trained predictive models respond with their output predictive results. The reverse derivation requester can select the first candidate-trained predictive models from the candidate-trained predictive models based on whether the output predictive results match the first confirmed test target result of the first test sample, as shown in steps S20′ to S22′. At this point, the requester can select the pre-trained predictive models with the required accuracy from all candidate-trained predictive models participating in federated learning. Next, the requester provides the second confirmed test target result of the second test sample to the above high-accuracy pre-trained predictive models (the first candidate pre-trained predictive models in the present embodiment), and the first candidate pre-trained predictive models perform reverse derivation to obtain the first candidate input parameters. The requester then compares the first candidate input parameters with the second confirmed test input parameters of the second test sample. The first candidate pre-trained predictive models with the first candidate input parameters matching or close to the second confirmed test input parameters have accurate reverse derivation capability and are thus selected as the pre-trained predictive models for the following decision variable calculation steps.

Additionally, for all pre-trained predictive models, the objective functions may be many-to-one functions, meaning that multiple different inputs processed by the pre-trained predictive model may generate the same predictive result. Therefore, the first candidate input parameters obtained by the reverse derivation of the first candidate pre-trained predictive models based on the second confirmed test target result may also be feasible input parameters, even if they do not match or are not close to the second confirmed test input parameters provided by the reverse derivation requestor. Therefore, the verification of the reverse derivation capabilities of the candidate pre-trained prediction models can also be performed by a validity confirming process. In practice, the validity confirming process can be executed by the reverse derivation requestor. For example, if the reverse derivation requestor is also one of the participants of federated learning, it can input the first candidate input parameters into its own pre-trained predictive model to confirm whether the predictive result matches or is close to the second confirmed test target result. Furthermore, if the reverse derivation requestor is not a participant of federated learning, or if multiple validity verifications are needed, the validity confirming process can provide the first candidate input parameters to multiple participants of federated learning to be input into the pre-trained predictive models to confirm whether the predictive results match or are close to the second confirmed test target result. Therefore, the first candidate pre-trained predictive models passing the validity confirming process would also have accurate reverse derivation capability, so that they can be selected as the pre-trained predictive models for the following decision variable calculation steps.

In short, the present embodiment firstly provides confirmed test input parameters to select the pre-trained predictive models and the corresponding participants of federated learning with the output results meeting the requirements, and then the present embodiment provides a confirmed target result to select the pre-trained predictive models and the corresponding participants of federated learning with the reverse derivation capabilities meeting the requirements.

In summary, the decision variable calculation method of the present invention allows the reverse derivation of decision variables for specific target result to be executed by the pre-trained predictive models provided by multiple participants in federated learning without performing federated learning. The reverse derivation requester can use the pre-trained predictive models of the participants in federated learning to reversely derive the input parameters from the target result and provide loss functions, and then aggregate them to form the total input parameter and the total loss function. An optimization problem is constructed by the total input parameter and the total loss function, and the optimization problem can be solved for calculating the total input parameter as the decision variables. By the decision variable calculation method of the present invention, specific participants of federated learning or the entities outside of federated learning can apply reverse derivation requests and directly select collaborators but not through the federated model produced by federated learning. It would avoid the more complex machine learning and reverse derivation procedures. Additionally, the decision variable calculation method of the present invention ensures that participants in federated learning do not need to exchange any susceptible and private data samples from their training datasets or exchange the model parameters of their own pre-trained predictive models. It reduces the procedural complexity and improves the data confidentiality.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A decision variable calculation method for calculating decision variables, the decision variable calculation method comprising the following steps:
providing a plurality of pre-trained predictive models, the pre-trained predictive models being respectively obtained by performing machine learning on a plurality of local datasets through a machine learning method;
providing a target result and reversely deriving a plurality of input parameters for the target result by the pre-trained predictive models respectively;
respectively setting a plurality of loss functions corresponding to the pre-trained predictive models, assigning a first weight value to each of the loss functions and then summing them to generate a total loss function, wherein each of the loss functions is defined as the absolute value, square, or a monotonic increasing function of the difference between the function value of each of the pre-trained predictive models and the target result;
assigning a second weight value to each of the input parameters and then summing them to generate a total input parameter, and constructing the total input parameter and the total loss function as an optimization problem; and
solving the optimization problem to obtain the second weight value of each of the input parameters to calculate the total input parameter as the decision variables.

2. The decision variable calculation method of claim 1, wherein the step of solving the optimization problem further comprises the following steps:
respectively calculating a derivative of the total loss function to each of the second weight values;
combining the derivatives to form a direction; and
increasing the total input parameter by a step size along the direction and inputting it into the pre-trained predictive models to judge if the function value of the total loss function decreases.

3. The decision variable calculation method of claim 1, wherein the pre-trained predictive models are provided by a plurality of participants in a federated learning system.

4. The decision variable calculation method of claim 3, wherein the step of reversely deriving the input parameters for the target result by the pre-trained predictive models respectively further comprises the following steps:
a first participant of the participants comparing all samples in a first local dataset of the local datasets to the target result; and
making the samples in the first local dataset that match the target result as reference samples for reversely deriving the input parameters.

5. The decision variable calculation method of claim 3, wherein the step of reversely deriving the input parameters for the target result by the pre-trained predictive models respectively further comprises the following steps:
a second participant of the participants comparing all samples in a second local dataset of the local datasets to the target result to obtain a plurality of anchor samples, and forming a multi-dimensional subspace from the anchor samples;
determining an initial sample within the multi-dimensional subspace;
obtaining a direction of the initial sample within the multi-dimensional subspace, increasing the initial sample by a step size in the direction to form an intermediate sample, and inputting the intermediate sample into a second pre-trained predictive model provided by the second participant to confirm whether a predictive result generated by the second pre-trained predictive model approaches the target result; and
continuously performing the steps of determining the direction, increasing the intermediate sample by the step size, and inputting the intermediate sample into the second pre-trained predictive model until the predictive result generated by the second pre-trained predictive model matches the target result, and making the last intermediate sample as the input parameter corresponding to the second pre-trained predictive model.

6. The decision variable calculation method as described in claim 3, wherein the step of reversely deriving the input parameters for the target result by the pre-trained predictive models respectively further comprises the following steps:
a third participant of the participants setting a dummy layer connected to the input end of a third pre-trained predictive model to form a parameter predictive model, wherein the dummy layer is the input end of the parameter predictive model; and
setting the target result as the output of the parameter predictive model, inputting a training dataset comprising at least one all-one vector to the parameter predictive model for training, adjusting a plurality of arc weight values between the dummy layer and the third pre-trained predictive model by an optimizer of the machine learning method that generated the third pre-trained predictive model, and making the arc weight values as the input parameters corresponding to the third pre-trained predictive model.

7. The decision variable calculation method as described in claim 3, wherein the step of reversely deriving the input parameters for the target result by the pre-trained predictive models respectively further comprises the following steps:
a fourth participant of the participants comparing all samples of a fourth local dataset in the local datasets to the target result to obtain a plurality of anchor samples, and forming a multi-dimensional subspace from the anchor samples;
determining an initial sample within the multi-dimensional subspace;
by an optimizer employed by the fourth participant to generate a fourth pre-trained predictive model, performing a minimization calculation on an objective function of the fourth pre-trained predictive model to obtain a gradient, and taking the reverse of the gradient as a direction of the initial sample;
increasing the initial sample by a step size in the direction to form an intermediate sample, and inputting the intermediate sample into the fourth pre-trained predictive model to confirm whether a predictive result generated by the fourth pre-trained predictive model is close to the target result; and
continuously performing the steps of determining the direction, increasing the intermediate sample by the step size, and inputting the intermediate sample into the fourth pre-trained predictive model until the predictive result generated by the fourth pre-trained predictive model matches the target result, and making the last intermediate sample as the input parameter corresponding to the fourth pre-trained predictive model.

8. The decision variable calculation method as described in claim 7, wherein the step of reversely deriving the input parameters for the target result by the pre-trained predictive models respectively further comprises the following steps:
providing a plurality of confirmed decision variables and calculating a first vector for the confirmed decision variables;
obtaining corresponding sample parameters from the sample parameters of all samples in the fourth local dataset based on the confirmed decision variables, and calculating a second vector for the corresponding sample parameters;
comparing the first vector with the second vectors while also comparing the predictive result generated by the fourth pre-trained predictive model for all samples in the fourth local dataset with the target result to obtain a reference sample, wherein the second vector of the reference sample is close to or matches the first vector, and the predictive result of the reference sample is close to or matches the target result; and
making the reference sample as the initial sample.

9. The decision variable calculation method, as described in claim 1, further comprises the following steps:
providing a test sample, wherein the test sample comprises a plurality of confirmed test input parameters and a confirmed test target result; and
inputting the confirmed test input parameters into a plurality of candidate pre-trained predictive models, and selecting the candidate pre-trained predictive models having the output results matching the confirmed test target result as the pre-trained predictive models.

10. The decision variable calculation method, as described in claim 1, further comprises the following steps:
providing a first test sample, wherein the first test sample comprises a plurality of first confirmed test input parameters and a first confirmed test target result;
inputting the first confirmed test input parameters into a plurality of candidate pre-trained predictive models, and selecting the candidate pre-trained predictive models having the output results matching the first confirmed test target result as first candidate pre-trained predictive models;
providing a second test sample, wherein the second test sample comprises a plurality of second confirmed test input parameters and a second confirmed test target result; and
providing the second test target result to the first candidate-trained predictive models, the first candidate-trained predictive models reversely deriving a plurality of first candidate input parameters respectively, and selecting the first candidate-trained predictive models, having the first candidate input parameters matching or close to the second confirmed test input parameters, or having the first candidate input parameters meeting a validity confirming process, as the pre-trained predictive models.
